(19) United States
(12) Patent Application Publication
(10) Pub. No.: US 2015/0360432 A1
(43) Pub. Date: Dec. 17, 2015

(54) Trash Compactor with Refrigeration

(71) Applicant: Wesley Zhou, Laguna Niguel, CA (US)

(72) Inventor: Wesley Zhou, Laguna Niguel, CA (US)

(21) Appl. No.: 14/307,241

(22) Filed: Jun. 17, 2014

(51) Int. Cl. B30B 15/34; B65F 1/14; B30B 9/30

(52) U.S. Cl. CPC B30B 15/34; B30B 9/3035; B65F 1/1405

(57) ABSTRACT

A trash compactor having a bin which is moveable in and out of a housing, the housing comprising a plurality of joined-together metal panels including a rear panel and a refrigeration unit having a cooling grate attached to the rear panel so as to cool the contents of the bin.

### BACKGROUND OF THE DISCLOSURE

1. Field of the Disclosure

The subject disclosure relates to a trash compactor with a refrigeration mechanism to cool its contents and inhibit decay of garbage and other contents of the composition and concomitant production of undesirable odors.

2. Related Art

Trash compactors per se of many designs are known in the art.

### SUMMARY

According to an illustrative embodiment, apparatus is provided comprising a trash compactor having a bin which is moveable in and out of a housing, the housing comprising a plurality of joined-together metal panels including a rear panel, and a refrigeration unit having a cooling grate attached to the rear panel so as to cool the contents of the bin.

### BRIEF DESCRIPTION OF THE DRAWINGS

FIG. 1 is a side perspective view of an illustrative embodiment of a trash compactor with refrigeration.

FIG. 2 is a back perspective view of an illustrative embodiment of a trash compactor with refrigeration.

### DETAILED DESCRIPTION

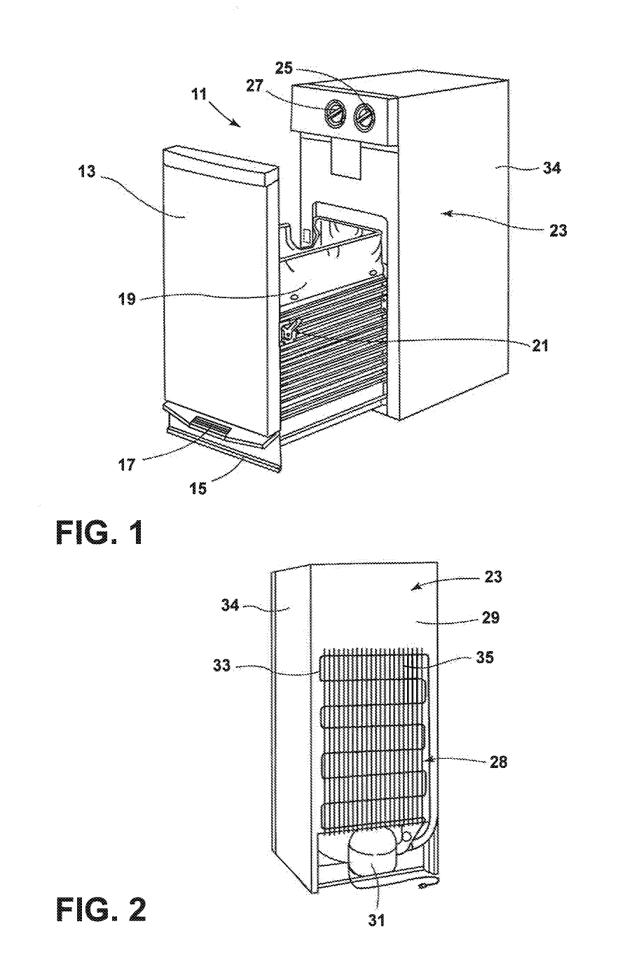

FIG. 1 illustrates a trash compactor 11 in an open position. The compactor 11 includes a door panel 13, a drawer handle 13, and a toe plate 15 including a touch-toe drawer opener 17. The compactor 11 further includes a bin 19 and a side lock latch 21. The bin 19 is mounted to slide or move in and out of a generally box-shaped trash compactor housing 23. A compactor off/start switch 25 and refrigeration switch 27 are also provide. In one embodiment, the refrigeration switch 27 includes off, “low,” “medium,” and “high” settings.

From FIG. 2 it can be seen that a refrigeration apparatus 28 is attached to a rear panel 29 of the housing 23. The refrigeration apparatus 28 includes a compressor 31 and serpentine heat exchange piping 33. The heat exchange piping 33 is attached to a grate 35 comprising a plurality of parallel bars which are attached to the rear panel 29. The rear panel 29 and side panels, e.g., 34, are interconnected metal panels, for example, such as steel or aluminum, and thus are cooled by the grate when the refrigeration unit is in operation.

The refrigeration unit 28 may operate according to a conventional vapor compression cycle. In this cycle, a circulating refrigerant such as R134a enters the compressor 31 as low-pressure vapor at or slightly above the temperature of the refrigerator interior. The vapor is compressed and exits the compressor 31 as high-pressure superheated vapor. The superheated vapor travels under pressure through coils or tubes 33 comprising a condenser, which is passively cooled by exposure to air in the room. The condenser cools the vapor, which liquefies. As the refrigerant leaves the condenser, it is still under pressure but is now only slightly above room temperature. This liquid refrigerant is forced through a metering or throttling device, also known as an expansion valve (essentially a pin-hole sized constriction in the tubing) to an area of much lower pressure. The sudden decrease in pressure results in explosive-like flash evaporation of a portion (typically about half) of the liquid. The latent heat absorbed by this flash evaporation is drawn mostly from adjacent still-liquid refrigerant, a phenomenon known as auto-refrigeration. This cold and partially vaporized refrigerant continues through the coils or tubes of an evaporator unit. A fan blows air across these coils or tubes and the refrigerant completely vaporizes, drawing further latent heat from the air. Refrigerant leaves the evaporator, now fully vaporized and slightly heated, and returns to the compressor inlet to continue the cycle.

The trash compactor 11 may be of various designs. Most trash compactors share a basic design; a horizontal platen is pressed downwards to compress trash into a receptacle at the bottom of the trash compactor. In one embodiment, a scissors-type mechanism is operated by a horizontal screw actuator. One set of feet are connected to the platen and another set of feet slide in a pair of tracks or on a rack-and-pinion of the platen. As the platen is forced downward to compress the trash, the screw experiences ever increasing bending moments and the forces from the scissors mechanism on the platen are applied in an increasingly asymmetric manner. In another design, an electric motor powering the compacting mechanism moves up and down with the compacting mechanism. Another trash compactor design requires two vertical screws to drive the compacting mechanism and stabilize the platen.

One embodiment of a trash or refuse compactor adapted particularly for household use may be advantageously built into a kitchen counter to save kitchen space and includes a housing that houses a lower trash receptacle and a compacting mechanism mounted above the receptacle. The receptacle is adapted to be pulled out of the housing similar to a cabinet drawer to provide access for depositing trash into the receptacle. The compacting mechanism includes a scissor jack or pantographic linkages driven by a drive screw to alternatively extend or retract a compacting head. With the receptacle drawer closed so that the receptacle is positioned directly below the compacting mechanism, the compacting mechanism is adapted to extend the compacting head downward into the receptacle to compact the trash or refuse deposited therein. After compaction, the compacting mechanism retracts the compacting head from the receptacle so that the receptacle drawer may be opened and more trash deposited. Such a trash or refuse compactor is well-suited for household use since it may be incorporated into a kitchen counter similarly to other built-in appliances such as dishwashers.

Thus, those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. Apparatus comprising:
a trash compactor having a bin which is moveable in and out of a housing, the housing comprising a plurality of joined-together metal panels including a rear panel; and
a refrigeration unit having a cooling grate attached to said rear panel so as to cool the contents of the bin.

2. The apparatus of claim 1 further comprising a switch configured to control said refrigeration unit and mounted in a front panel of said trash compactor.
